(19) United States
(12) Patent Application Publication
(10) Pub. No.: US 2013/0256475 A1
(43) Pub. Date: Oct. 3, 2013

(54) Article Supports and Adapters Therefor

(71) Applicant: Vince S. Warner, Alpine, UT (US)

(72) Inventor: Vince S. Warner, Alpine, UT (US)

(73) Assignee: Field Optics Research, Orem, UT (US)

(21) Appl. No.: 13/743,537

(22) Filed: Jan. 17, 2013

Related U.S. Application Data
(60) Provisional application No. 61/587,447, filed on Jan. 17, 2012.

(51) Int. Cl. F16M 11/04; A47B 3/00

(52) U.S. Cl. CPC F16M 11/041; A47B 3/00
USPC 248/176.1; 108/28

(57) ABSTRACT

Disclosed herein are embodiments of an adapter for affixing useful articles upon a support system. A first article adapter is provided. In some devices, binoculars are outfitted with a connecting rod that the adapter can snap into. Other article adapters include a camera mount and a gun mount. A second support adapter can then be attached to a stand, such as a tripod, bipod, or monopod, or other support structure using known means.

### CROSS-REFERENCES TO RELATED APPLICATIONS

The present application claims priority as a non-provisional perfection of prior filed U.S. provisional application No. 61/587,447, filed Jan. 17, 2012, and incorporates the same by reference in its entirety herein.

### FIELD OF THE INVENTION

The disclosure relates to supports and connectors for supports and more particularly relates to supports usable with various sporting goods.

### BACKGROUND FO THE INVENTION

Enjoying the outdoors is a pastime for many individuals. One difficulty in enjoying the outdoors is the need to pack equipment—you are limited to what you can easily carry. To this end many products and innovations have been developed to help individuals pack and carry useful items when enjoying the outdoors in their particular way. Device supports have thus been developed and manufactured to aid in holding, supporting, carrying, stabilizing and stowing a wide range of articles. Generally speaking, such supports need to be small and stowable in and of themselves and must be easily assembled and/or attached to the article they are intended to support.

The present invention is a quick detach support system for various articles. A universal coupling system is utilized throughout the system so that various support adapters for various articles may be used in the system.

### SUMMARY OF THE INVENTION

The present invention's general purpose is to provide a new and improved quick-detach support system that is usable with articles usually packed with an individual while enjoying or documenting the outdoors. To accomplish this objective, an adapter is attached to some form of support while another is attached to the article desired to be supported. The two adapters are supplied with the quick detach coupling apparatus and may then mate in an effort to attach the article on the desired support.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting. Of particular note, one commonly packed support item is a tripod or bipod. Tripods are usually used by photographers who need stability when taking pictures. Bipods are used by some hikers to help support items on themselves or their equipment, such as a backpack like one described in the co-pending Application entitled “Optical Support Device” and filed Jan. 17, 2013 as U.S. patent application Ser. No. 13/743,566, which is incorporated in its entirety by reference herein. Accordingly, the support adapter of the invention is being described herein as being usable on a tripod or bipod, however, it is to be understood that the use of these terms is only in a general sense and that any item may be used to support the adapters herein described, if being made to work with said item. Likewise, a number of embodiments of the article adapters are described, with particular emphasis on a novel binocular adapter. Adapters may be made for other articles.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a preferred embodiment of the invention in use with a pair of binoculars.

FIG. 2 is a perspective view of the connecting rod used in the embodiment depicted in FIG. 1.

FIG. 3 is a side elevation of the connecting rod of FIG. 2.

FIG. 4 is a top plan view of the connecting rod of FIG. 2.

FIG. 5 is a perspective view of a platform-style adapter, as depicted in the embodiment of the invention shown in FIG. 1.

FIG. 6 is a perspective view of an alternate platform-style adapter.

FIG. 7 is a perspective view of an alternate bipod adapter.

FIG. 8 is a perspective view of the alternate platform-style adapter of FIG. 6 with a connecting rod of FIG. 2 thereon.

FIG. 9 is a perspective view of a camera mount adapted for use with the present invention.

FIG. 10 is a side elevation of the camera mount of FIG. 9.

FIG. 11 is a perspective view of the camera mount of FIG. 9 mounted upon the bipod adapter of FIG. 7.

FIG. 12 is a perspective view of a gun mount mounted upon the bipod adapter of FIG. 7.

FIG. 13 is a partially transparent perspective view of a table adapter for use with the present invention.

FIG. 14 is a perspective view of the supports for the table adapter of FIG. 13.

FIG. 15 is a side elevation of the table supports of FIG. 14.

FIG. 16 is a side elevation of the table supports of FIG. 14, stowed and mounted upon the platform adapter of FIG. 6.

### DETAILED DESCRIPTION OF PREFERRED EMBODIMENTS

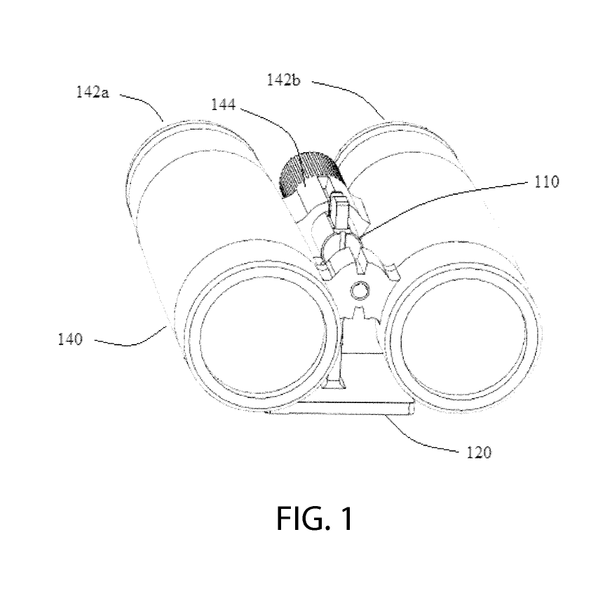

FIG. 1 shows an embodiment of the invention for mounting binoculars 140 on a support stand. Optical devices other than binoculars may be used in other embodiments of the invention. In this first embodiment, the binoculars 140 comprise two telescopes 142a,b and a bridge 144. The binoculars 140 are connected to a connecting rod 110 that allows the binoculars 140 to interface with the support adapter 120. The support adapter 120 can then connect to a tripod, bipod, monopod, or any similar support stand. The support adapter 120 and connecting rod 110 are designed to be easily attached or detached from one another.

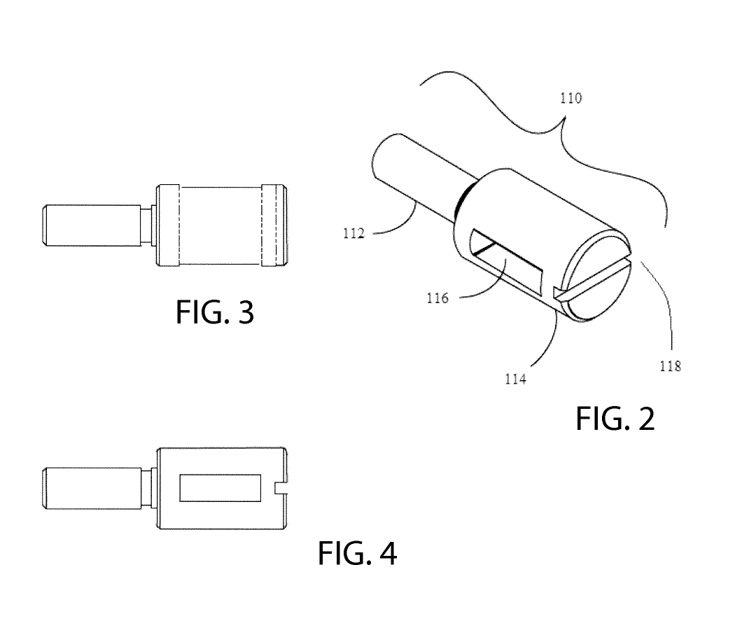

FIGS. 2-4 show the connecting rod 110 in more detail. The connecting rod 110 is cylindrical and includes a narrow cylindrical end 112 that can be inserted into and attached to the binoculars 140. In this embodiment, the narrow end 112 is threaded and may be screwed into the bridge 144 of the binoculars 140. In other embodiments, the connecting rod 110 may be attached to the binoculars 140 using any means known in the art. A wider cylindrical end 114 remains exposed. The wider end 114 comprises a slot 116 that goes entirely through the connecting rod 110. The slot 116 is rectangular-shaped and used for connection to the adapter 120. The connecting rod 110 also comprises a notch 118 on the end of the connecting rod 110. The notch 118 is shaped so that a flat-head screw driver may be used to screw the connecting rod 110 into the binoculars 140.

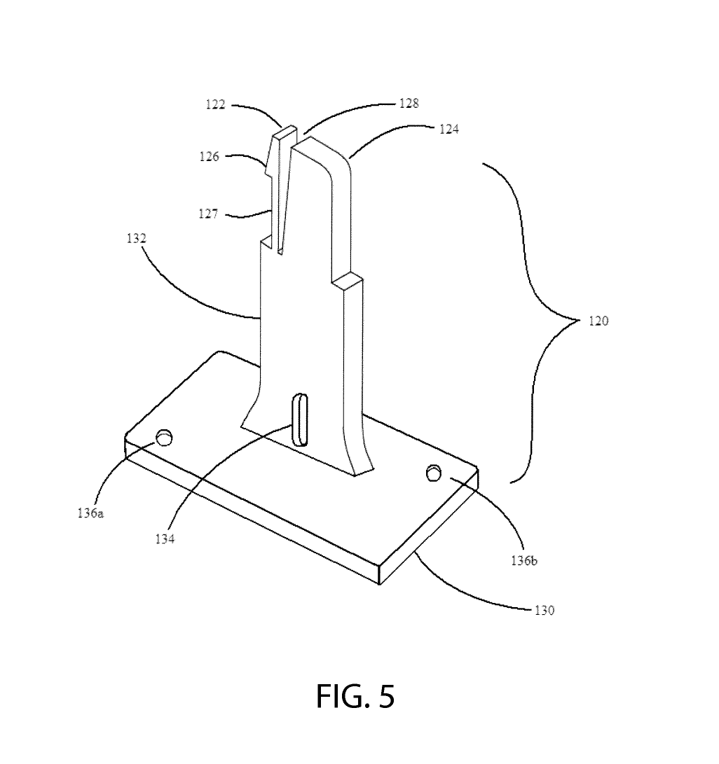

FIG. 5 shows the support adapter 120 in more detail. The support adapter 120 is designed to snap into the slot 116 of the connecting rod 110. Accordingly, the support adapter 120 includes adjacent narrower 122 and wider 124 tabs extending in parallel from the top of a fin-shaped neck 132 with a gap 128 in between the tabs 122 and 124. The narrower tab 122 contains a trapezoidal-shaped end 126. Where the trapezoidal shape 126 is widest, the width of the narrower tab 122, gap 128, and wider tab 124 should be larger than the slot 116. At the trapezoidal shape's 126 narrowest, the width of the narrower tab 122, gap 128, and wider tab 124 should be smaller than the slot 116. The non-trapezoidal section 127 of the narrower tab 122 should be slightly longer than the depth of the slot 116. This will allow the trapezoidal-shaped end 126 to extend beyond the slot 116 and lock the support adapter 120 to the connecting rod 110.

The narrower tab 122 may be made from a rigid material such that it is still somewhat flexible. However, the narrower tab should return to its previous position and not permanently deform. The material for the tabs 122 and 124 should also be rigid enough to prevent the narrower tab 122 from moving towards the wider tab 124 without being squeezed. The narrower tab 122 may be squeezed towards the wider tab 124 to allow the support adapter 120 to fit into the slot 116. Once in the slot 116, the narrower tab 122 returns to its original position and cannot be removed without again squeezing the narrower tab 122 towards the wider tab 124. During insertion, the slot 116 may apply the pressure to squeeze the narrower tab 122 closer to the wider tab 124 as the slot 116 is slid along the trapezoidal-shaped end 126 in the direction of increasing width. This will allow the support adapter 120 to enter the slot 116 without squeezing by the user. However, the support adapter 120 cannot be similarly removed without squeezing from the user. This will prevent the support adapter 120 from being unintentionally dislodged from the connecting rod 110.

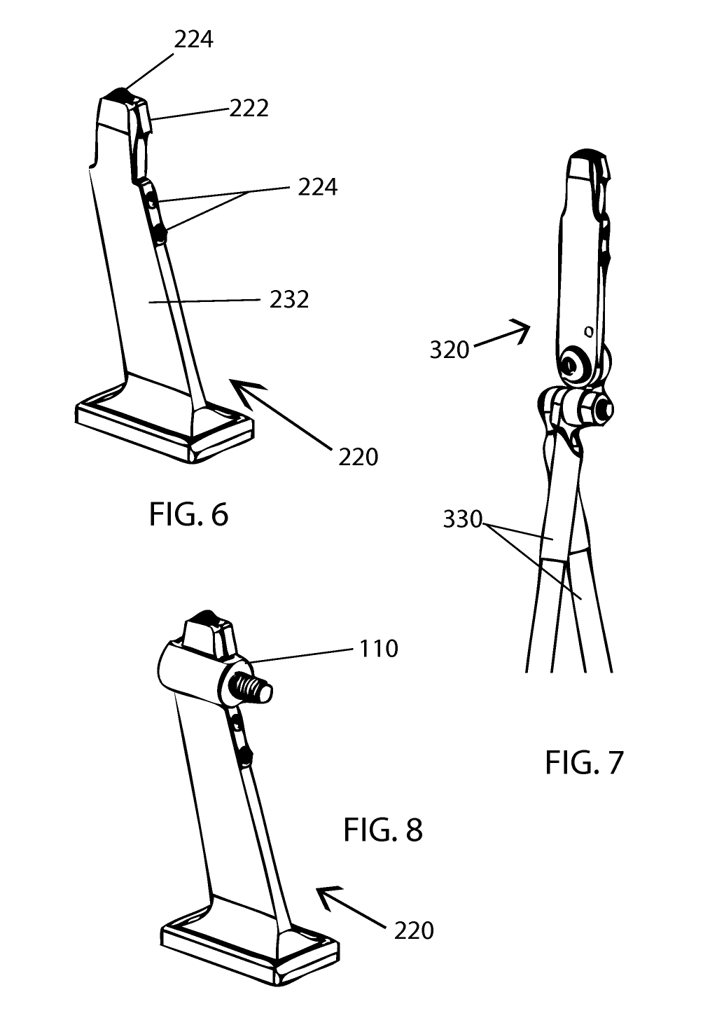

In other embodiments, FIGS. 6-8, the narrower tab is a separate piece 222 that is permanently affixed to the neck 232 via means known in the art such as rivets, screws, or bolts 224. In some instances, the narrower tab 222 is a strip of metal or plastic thin enough to provide the flex needed for the alternate support adapter 220 to be inserted into the connecting rod 110 (FIG. 8). Rather than having a trapezoidal-shaped end, the strip is bent outward at a 90° angle where the base of the trapezoid would be and then bent back inward at an acute angle, thereby creating a similar trapezoidal profile. The 90° bend prevents the adapter 220 from being removed from the connecting rod 110, while the acute bend allows the slot 116 to squeeze the narrow tab 222 towards the neck 232 during insertion. In still other embodiments, more than two tabs may be used.

Referring back to FIG. 5, the neck 132 is attached at its bottom to the base 130 of the support adapter 120. The base 130 is perpendicular to the neck 132. In this embodiment, the neck 132 and base 130 are attached due to being fabricated out of a single piece of material. The base 130 of the support adapter 120 is able to connect to a tripod or similar stand using any mean known in the prior art. In this embodiment, the base includes screw slots 136a, 136b for attachment to the tripod with screws. The neck 132 may also include additional slots in it 134. It is, of course, to be readily understood that the base depicted in these drawings is generic and that any type of base may be fitted with the dual tab interfaces described above and still be considered within the purview of this invention, as is shown in FIG. 7 where bipod legs 330 are affixed to a blade-shaped support adapter 320.

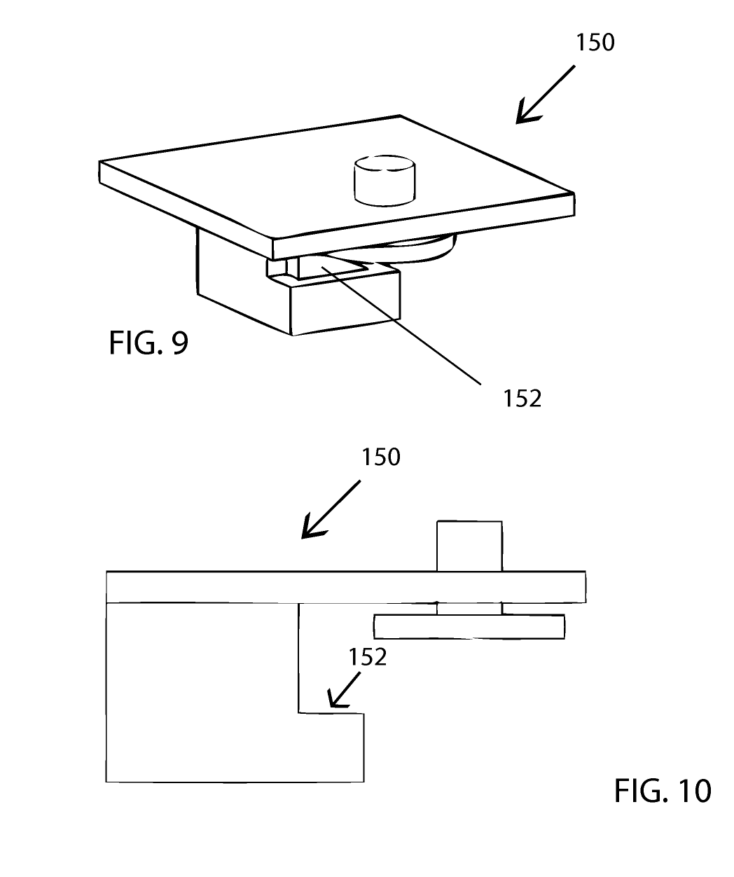

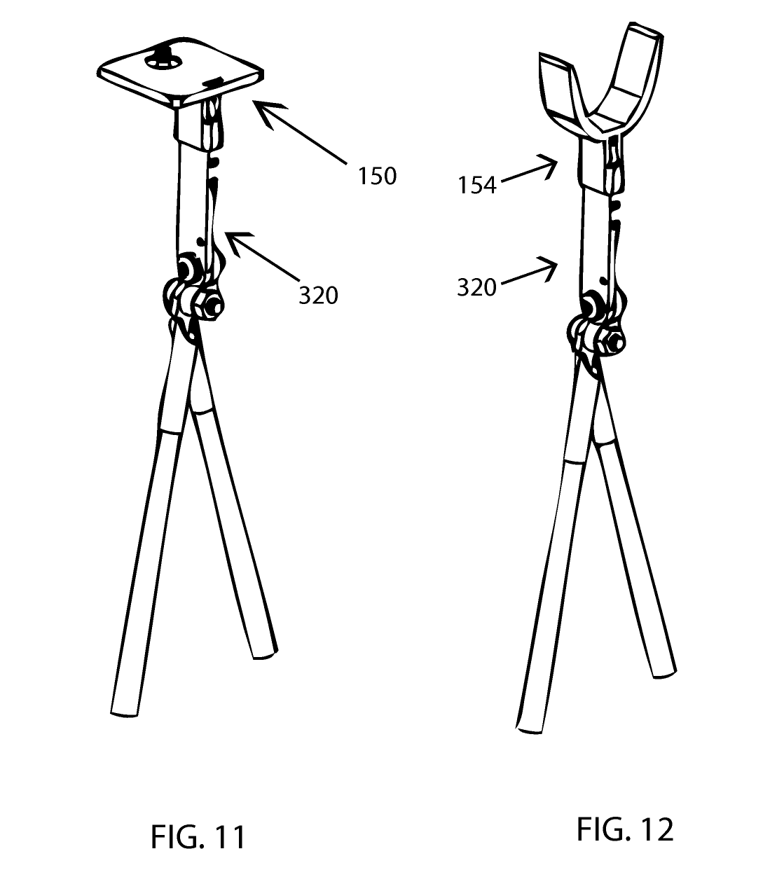

Other mounts may be adapted to work with the present invention. FIGS. 9-11 depict a camera mount 150 that has been fitted with a slot 152 of the same dimensions as slot 116, thereby allowing its use with a base according to the present invention. Likewise, gun mount 154, shown in FIG. 12, is fitted with a similar slot. Any type of support and any type of base may be utilized with the present invention where a quick detach but secure connection is desirable. Since the interface requires a slot and access to the top of the neck 132, in particular the narrower tab 122, both ends of the slot must be exposed in some fashion, one end for insertion of the neck 132 and the other for interface of the narrower tab 122 and for access to the tabs for release.

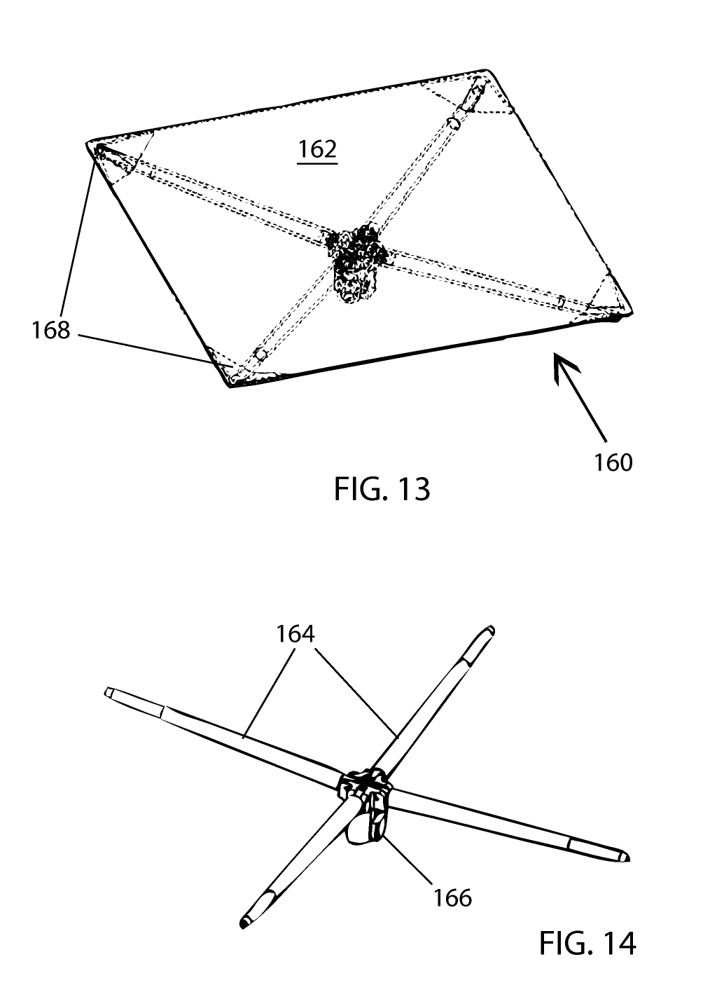

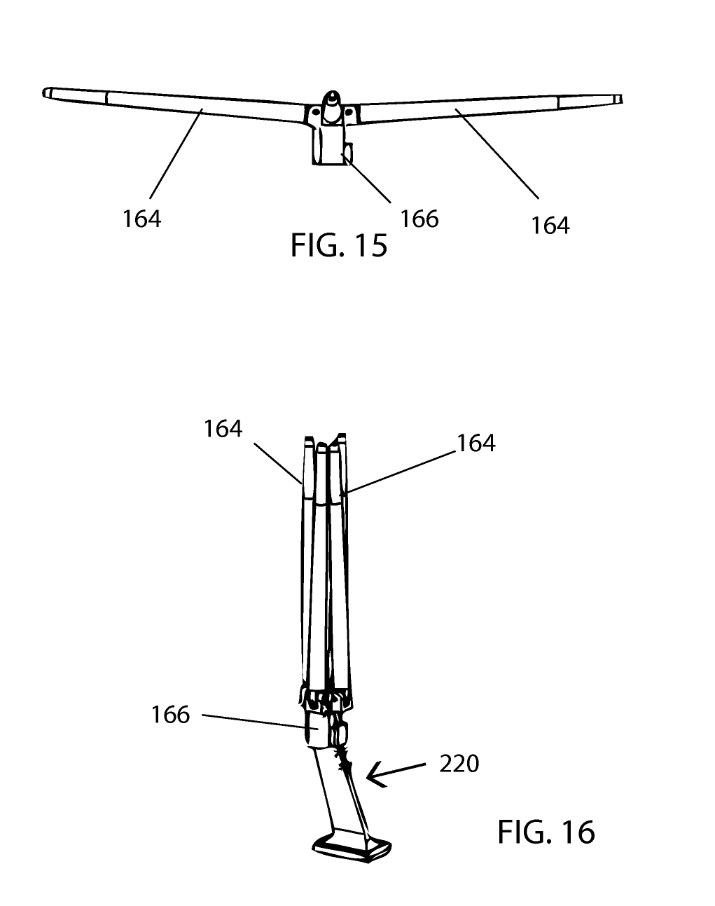

Of particular interest is a table mount 160, shown in FIGS. 13-16. A foldable surface 162 is stretched over a plurality of legs 164 joined at an interface 166 suitable for use with the present invention. The legs 164 fold, as shown in FIG. 16, and the whole table adapter is attachable to any of the adapters disclosed above. Deploying the table then is simply a matter of splaying the legs 164 and inserting them into pockets 168 provided on the underside of the table surface 162 and connecting the interface 166 to a support adapter 220 and attaching that support adapter 220 to a desired and suitable support, such as a tripod. The surface 162 may be made of any foldable material, such as cloth or plastic.

Although the present invention has been described with reference to preferred embodiments, numerous modifications and variations can be made and still the result will come within the scope of the invention. No limitation with respect to the specific embodiments disclosed herein is intended or should be inferred. The scope of the present invention should, therefore, be determined only by the following claims.

I claim:

1. A support system for connecting an article to a support comprising:
a. an article mount further comprising:
i. a connection interface by which the article mount may be attached to an article desired to be supported; and
ii. a slot disposed within the article mount such that the slot has two exposed ends; and
b. a support adapter comprising a neck and a base,
wherein the neck can be inserted into the slot and must be squeezed to be removed from the slot and wherein the base is attached to a support.

2. The support system of claim 1, the article mount comprising a rod attachable to an optical device, wherein the rod comprises a slot disposed entirely through the rod.

3. The support system of claim 2, wherein the optical device is a pair of binoculars that further comprise a bridge that the rod may be screwed into.

4. The support system of claim 1, the article mount being selected from the set of article adapters consisting of: a gun mount, a camera mount, and a table.

5. The support system of claim 1, the support being selected from the set of supports consisting of: a tripod, a bipod, and a monopod.

6. The support system of claim 1, wherein the slot is rectangular shaped.

7. The support system of claim 1, wherein the neck further comprises a narrow tab and an adjacent wide tab extending in parallel from the neck.

8. The support system of claim 7, wherein the narrow tab is connected to the neck with screws.

9. The support system of claim 7, wherein the narrow tab is resilient and flexible and thereby deforms and returns to its previous shape.

10. The support system of claim 7, wherein the narrow tab is made from a material selected from the set of materials consisting of metal and plastic.

11. The support system of claim 8, wherein the narrow tab has a trapezoidal-shaped end.

12. The support system of claim 1, wherein the neck is fin shaped.

13. The support system of claim 1, wherein the neck and base are fabricated from a single piece of material.

14. A method of attaching an optical device to a support stand comprising:
attaching an optical device to a rod, wherein the rod comprises a slot disposed entirely through the rod;
connecting the rod to a support adapter comprising a neck and a base, wherein the neck is inserted into the slot and must be squeezed to be removed from the slot; and
affixing a support system to the base.

15. The method of claim 14, wherein the optical device comprises binoculars.

16. The method of claim 14, wherein the support stand is selected from the set of support stands consisting of: a tripod, a bipod, and a monopod.

17. The method of claim 14, wherein the attaching step further comprises screwing the rod into the optical device.

18. The method of claim 14, wherein the support adapter comprises a narrow tab and an adjacent wide tab extending in parallel from the neck.

19. A table comprising:
a. a foldable table surface having pockets on an underside;
b. an article mount further comprising:
i. a connection interface by which the article mount may be attached to an article desired to be supported;
ii. a slot disposed within the article mount such that the slot has two exposed ends; and
iii. a plurality of legs hingedly attached to the connection interface; and
c. a support adapter comprising a neck and a base;
wherein the neck can be inserted into the slot and must be squeezed to be removed from the slot and wherein the base is attached to a support.
